(19) United States
(12) Patent Application Publication
(10) Pub. No.: US 2008/0211771 A1
(43) Pub. Date: Sep. 4, 2008

(54) Approach for Merging Scaled Input of Movable Objects to Control Presentation of Aspects of a Shared Virtual Environment

(75) Inventor: James D. Richardson, Philomath, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: NATURALPOINT, INC., Corvallis, OR (US)

(21) Appl. No.: 12/041,575

(22) Filed: Mar. 3, 2008

Related U.S. Application Data
(60) Provisional application No. 60/904,732, filed on Mar. 2, 2007.

(51) Int. Cl. G06F 3/033

(52) U.S. Cl. 345/158

(57) ABSTRACT

A system for controlling operation of a computer. The system includes, a sensing apparatus configured to obtain positional data of a sensed object controllable by a first user, such positional data varying in response to movement of the sensed object, and engine software operatively coupled with the sensing apparatus and configured to produce control commands based on the positional data, the control commands being operable to control, in a multi-user software application executable on the computer, presentation of a virtual representation of the sensed object in a virtual environment shared by the first user and a second user, the virtual representation of the sensed object being perceivable by the second user in a rendered scene of the virtual environment, where the engine software is configured so that the movement of the sensed object produces control commands which cause corresponding scaled movement of the virtual representation of the sensed object in the rendered scene that is perceivable by the second user.

### CROSS REFERENCE TO RELATED APPLICATION

The present application claims priority to Provisional Application Ser. No. 60/904,732, filed Mar. 2, 2007, titled “Systems and Methods for Merging Scaled Input to Control a Computer from Movable Objects into a Shared Reality”, the entire contents of which is incorporated herein by this reference in its entirety and for all purposes.

### TECHNICAL FIELD

The present description relates to systems and methods for using a movable object to control a computer.

### BACKGROUND AND SUMMARY

Motion-based control systems may be used to control computers and more particularly, motion-based control systems may be desirable for use with video games. Specifically, the interactive nature of control based on motion of a movable object, such as for example, a user's head may make the video gaming experience more involved and engrossing because the simulation of real events may be made more accurate. For example, in a video game that may be controlled via motion, a user may move their head to different positions in order to control a view of a rendered scene in the video game. Since the view of the rendered scene is linked to the user's head movements the video game control may feel more intuitive and the authenticity of the simulation may be improved.

In one example configuration of a motion-based control system, a user may view a rendered scene on a display screen and may control aspects of the rendered scene (e.g. change a view of the rendered scene) by moving their head. In such a configuration, the display screen may be fixed whereas the user's head may rotate and translate in various planes relative to the display screen. Further, due to the relationship between the fixed display screen and the user's head, the control accuracy of the user with regard to control aspects of the rendered scene may be limited by the user's line of sight of the display screen. In other words, when the user's head is rotated away from the screen such that the user does not maintain a line of sight with the display screen, the user may be unable to accurately control the view of the rendered scene. Thus, in order for the user to maintain accurate control of the rendered scene, the movements of the user's head may be scaled relative to movements of the rendered scene in order for the user to maintain a line of sight with the display screen. In other words, the magnitude of the user's actual head movements may be amplified in order to produce larger virtual movements of the virtual perspective on the display screen. In one particular example, a user may rotate their head 10° to the left along the yaw axis and the motion-based control system may be configured to scale the actual rotation so that the virtual perspective in the rendered scene may rotate 90° to the left along the yaw axis. Accordingly, in this configuration a user may control an object or virtual perspective through a full range of motion within a rendered scene without losing a line of sight with the display screen.

Furthermore, the game play experience of a user controlling a video game based on motion control may be enhanced in a multi-player environment. Multi-player video games may facilitate social interaction between two or more users. Multi-player video games may be desirable to play because a user may virtually interact with other actual users to produce a game play experience that is organic and exciting, since various different actual users may perform actions during game play that are unpredictable whereas actions of preprogrammed artificial intelligence employed in single-player video games may be perceived by a user as canned or repetitive.

Thus, by facilitating a plurality of users to control aspects of a multi-player video game using motion based control of movable objects having unique correspondence to virtual objects which may be scaled in the multi-player video game, the game play experience of the multi-player video game may be both unpredictable and engrossing and therefore enhanced since the users may perceive virtual objects having virtual scaled movement that corresponds to actual movement of other actual users.

### BRIEF DESCRIPTION OF THE DRAWINGS

FIG. 1 is a schematic block diagram of an example system for controlling a computer based on position and/or movement (positional changes) of a sensed object.

FIG. 2 depicts the sensed object of FIG. 1 and an exemplary frame of reference that may be used to describe position of the sensed object based on sensed locations associated with the sensed object.

FIG. 3 is a schematic depiction of an example of controlling a computer based on position and/or movement of a head of a user.

FIG. 4 is a schematic depiction of an example of controlling a computer based on position and/or movement of a movable object controllable by a user.

FIGS. 5a-5h depict an example of two users controlling presentation of different rendered scenes of a shared virtual environment via scaled movement of sensed objects controlled by the users.

FIG. 6 depicts an example where two users interact with a shared virtual environment via different rendered scenes presented on different display devices.

FIG. 7 depicts an example where two users interact with a shared virtual environment via the same rendered scene presented on different display devices.

FIG. 8 depicts an example where two users interact with a shared virtual environment via the same rendered scene presented on a single display device.

FIG. 9 depicts an example where two users interact with a shared virtual environment via different rendered scenes presented concurrently on a single display device.

FIGS. 10a-10b depict an example where two users interact with a shared virtual environment via different rendered scenes presented alternately on a single display device capable of interleaved presentation.

FIG. 11 depicts an exemplary method of arbitrating scaled movement of different sensed objects in a shared virtual environment.

### DETAILED DESCRIPTION

The present description is directed to software, hardware, systems and methods for controlling a computer (e.g., controlling computer hardware, firmware, a software application running on a computer, etc.) based on the real-world physical position and/or movements of a user's body or other external object (referred to herein as the “sensed object”). More particularly, many of the examples herein relate to using movements of a user's body or other external object to control a software program. The software program may be a virtual reality program that is viewable or perceivable by a user of the program through rendered scenes presented on a display. In many such applications, the application may generate a large or perhaps infinite number of rendered scenes. In one example, the virtual reality program may be a virtual reality video game, such as an automobile racing simulation where a user controls a view from the driver's seat of a virtual automobile by moving the user's head.

In some cases, the virtual reality software application may be a multi-user software application, in which, a plurality of users may share a virtual environment. That is, a virtual environment may be perceivably by multiple users, and each of the users may effect control over the virtual environment via manipulation of an external sensed object. Further, in some cases, the movement of the user's body or other external object may be scaled in the virtual environment and the scaled movement may be perceivable by other users. Moreover, movement by different users represented in the virtual environment may be scaled differently and the differently scaled movement may be perceivable by other users of the virtual environment.

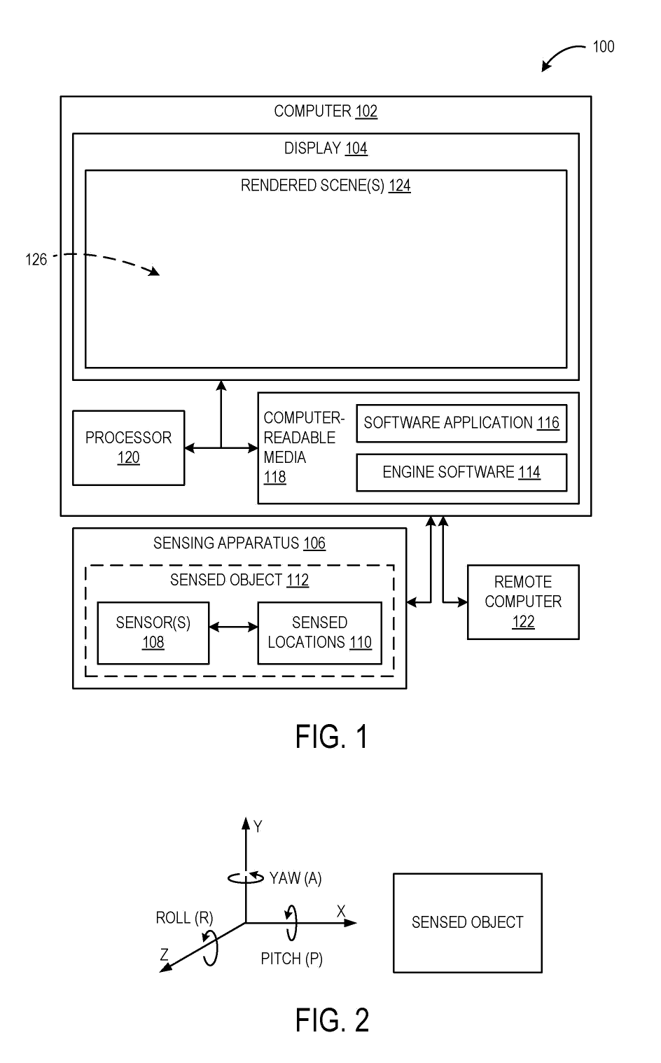

FIG. 1 schematically depicts a motion-based control system 100 according to the present disclosure. A sensing apparatus 106 may include sensor or sensors 108, which are configured to detect, movements of one or more sensed locations 110, relative to a reference location or locations. According to one example, the sensors(s) is/are disposed or positioned in a fixed location (e.g., a camera or other optical sensing apparatus mounted to a display monitor of a desktop computer) and one or more sensed locations 110 are affixed or statically positioned on or proximate to a sensed object 112 (e.g., features on a user's body, such as reflectors positioned at desired locations on the user's head).

According to another embodiment, the sensor(s) is are/located on sensed object 112. For example, in the setting discussed above, the camera (in some embodiments, an infrared camera may be employed) may be secured to the user's head, with the camera being used to sense the relative position of the camera and a fixed sensed location, such as a reflector secured to a desktop computer monitor. Furthermore, multiple sensors and sensed locations may be employed, on the sensed object and/or at the reference location(s).

In the above example embodiments, position sensing may be used to effect control over rendered scenes or other images displayed on a display monitor positioned away from the user, such as a conventional desktop computer monitor or laptop computer display. In addition to or instead of such an arrangement, the computer display may be worn by the user, for example in a goggle type display apparatus that is worn by the user. In this case, the sensor and sensed locations may be positioned either on the user's body (e.g., on the head) or in a remote location. For example, the goggle display and camera (e.g., an infrared camera) may be affixed to the user's head, with the camera configured to sense relative position between the camera and a sensed location elsewhere (e.g., a reflective sensed location positioned a few feet away from the user). Alternatively, a camera or other sensing apparatus may be positioned away from the user and configured to track/sense one or more sensed locations on the user's body. These sensed locations may be on the goggle display, affixed to some other portion of the user's head, etc.

Although the above examples are described in the context of optical sensing, it will be appreciated that sensing apparatus 106 may use any suitable sensing technology to determine a position and/or orientation of sensed locations 110 representative of sensed object 112. Nonlimiting examples of sensing technology that may be employed in the sensing apparatus include capacitors, accelerometers, gyrometers, etc.

Sensing apparatus 106 my be operatively coupled with computer 102 and, more particularly, with engine software 114, which receives and acts upon position signals or positional data obtained by sensing apparatus 106 based on the sensed object (e.g., the user's head). Engine software 114 receives these signals and, in turn, generates control commands that may be applied to effect control over software application 116. In one example, software application 116 may be configured to generate a virtual environment 126 perceivable by a user through one or more rendered scenes 124. For example, the software application may be a first-person virtual reality program, in which position of the sensed object is used to control presentation of a first person virtual reality scene of the virtual environment to the user (e.g., on a display). As another example, the software application may be a third-person virtual reality program, in which position sensing is used to control presentation of a rendered scene that includes a virtual representation of an object in the virtual environment having movement corresponding to the sensed position. Additionally, or alternatively, rendering of other scenes may be controlled in response to position sensing or positional data. Also, a wide variety of other hardware and/or software control may be based on the position sensing, in addition to or instead of rendering of imagery. Thus, it will be appreciated that engine software 114 may generate control commands based on the positional data that may be applied to effect control over software and/or hardware of computer 102.

Furthermore, in some embodiments, engine software 114 may be configured to generate control commands that may be used by a software application executable on a remotely located computer 122. For example, a user may use a sensed object and/or position sensing apparatus to interact with a software application such as a multi-player virtual reality video game that is executable on a local computer. Further, other users may play instances of the multi-player virtual reality video game at remotely located computers that are in operative communication with the local computer of the user. In this example, the engine software may send control commands and/or positional data to the remotely located computers (e.g. via LAN (local area network, WAN (wide area network), etc.) which may be used to effect control of the video games on the remotely located computers to the other users. In some examples, the control commands generated at a local computer may be sent to a software application executable on a remotely located computer to the control a virtual representation of the sensed object in rendered scenes presented on a display of the remotely located computer. In some examples, control commands generated by the engine software may be sent to other types of remotely located computers, such as a server computer, for example.

In some embodiments, the engine software may be executable on a remotely located computer and may send control commands to a local computer. In some embodiments, the engine software may be executable by hardware of the sensing apparatus.

It will be appreciated that, in some embodiments, the engine software may be incorporated with the software application and/or may be specially adapted to the particular requirements of the controlled software. In some embodiments, the engine software may be specifically adapted to the particular requirements of a sensing apparatus. Further, in some embodiments, the engine software may be adapted for the particular requirements of both the applications software and the sensing apparatus.

Engine software 114 and/or software application 116 may be stored in computer-readable media 118. The computer-readable media may be local and/or remote to the computer, and may include volatile or non-volatile memory of virtually any suitable type. Further, the computer-readable media may be fixed or removable relative to the computer. The computer-readable media may store or temporarily hold instructions that may be executed by processor 120. Such instructions may include software application and software engine instructions.

Processor 120 is operatively coupled with computer-readable media 118 and display 104. Engine software 114 and/or software application 116 may be executable by processor 120 which, under some conditions, may result in presentation of one or more rendered scenes 124 to the user via display 104. In some embodiments, the computer-readable media may be incorporated with the processor (e.g., firmware). In some embodiments, the processor may include a plurality of processor modules in a processing subsystem that may execute software stored on the computer-readable media.

Display 104 typically is configured to present one or more rendered scenes 124 of virtual environment 126. Virtual environment 126 is generated by software application 116 and is perceivable by one or more users of computer 102 through presentation of the rendered scenes. For example, in an automobile racing game, the virtual environment may include various automobiles (including automobiles controlled by the user or users of the game) and a computerized racecourse/landscape through which the automobiles are driven. During gameplay, the user or users experience the virtual environment (i.e., the racecourse) through rendered scenes or views of the environment, which are generated in part based on the interaction of the player(s) with the game.

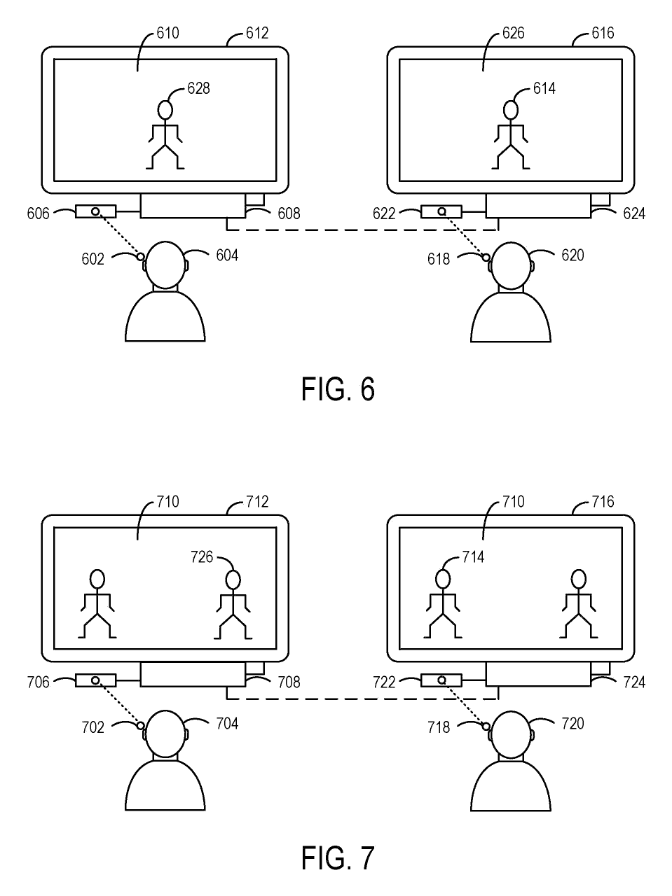

The rendered scene(s) may include various types of first person perspectives, third person perspectives, and other perspectives of the virtual environment. In some examples, one or more rendered scenes may include multiple perspectives. Further, in some cases, each of the multiple perspectives may be directed at or may be a virtual perspective of a different user. Exemplary embodiments of display configurations and presentation of rendered scene(s) will be discussed in further detail below with reference to FIGS. 6-10.

FIG. 2 depicts an example frame of reference that may be used to describe translational and rotational movement of a sensed object in three-dimensional space. The frame of reference for the sensed object may be determined based on a position of sensed locations 110 relative to sensors 108 of sensing apparatus 106 (shown in FIG. 1) since sensed object 112 may be at a position that is fixed relative to the sensed locations or the sensors.

In one particular example, the sensed locations may be three reflective members in a fixed configuration positioned in proximity to the head of a user in order to track movement of the user's head. The location of the reflective members relative to a fixed location may be determined using an infrared camera, for example. Assuming that the infrared camera is positioned in proximity to a computer display, the Z axis of the frame of reference would represent translation of the user's head linearly toward or away from the computer display point of reference. The X axis would then represent horizontal movement of the head relative to the reference, and the Y axis would correspond to vertical movement. Rotation of the head about the X axis is referred to as “pitch” or P rotation; rotation about the Y axis is referred to as “yaw” or A rotation; and rotation about the Z axis is referred to as “roll” or R rotation. Accordingly, the sensed object may translate and/or change orientation within the frame of reference based on the reference location, such as infrared LEDs (light emitting diodes),

It will be appreciated that in some embodiments more or less reflective members may be implemented. Furthermore, the use of reflective members and an infrared camera is exemplary only; other types of cameras and sensing may be employed. For example, sensing apparatus configuration may include a fixed array of infrared LEDs (light emitting diodes) that are sensed by an infrared camera. Indeed, for some applications, non-optical motion/position sensing may be employed in addition to or instead of cameras or other optical methods.

In embodiments in which three sensed locations are employed, the positional data that is obtained (e.g., by the camera) may be represented within the engine software initially as three points within a plane. In other words, even though the sensed object (e.g. the user's head) is translatable in three rectilinear directions and may also rotate about three rectilinear axes, the positions of the three sensed locations may be mapped into a two-dimensional coordinate space. The position of the three points within the mapped two-dimensional space may be used to determine relative movements of the sensed object (e.g., a user's head in the above example).

Movement of a sensed object may be resolved in the frame of reference by the engine software and/or software application. In particular, translational motion of the sensed object may be resolved along the X-axis, Y-axis, and Z-axis, each axis being perpendicular to the other two axes, and rotational motion of the sensed object may be resolved about each of the X-axis, Y-axis and Z-axis. It will be appreciated that the position/movement of the sensed object may be resolved in the frame of reference based on a predefined range of motion or an expected range of motion of the sensed object within the bounds of the sensing apparatus. Accordingly, a position of a sensed object relative to a reference point may be resolved along the translational and rotational axes to create a unique one-to-one correspondence with control commands representative of the position/movement of the sensed object. In this way, movement of the sensed object may correspond to movement of a virtual representation of the sensed object in a rendered scene in six degrees of freedom (i.e. X, Y, Z, P, R, A).

Furthermore, movement of the sensed object in a space defined by the bounds of the sensing apparatus may be scaled to produce scaled movement of a virtual perspective or virtual representation of the sensed object in a rendered scene. Scaling may be defined herein as an adjustment of a parameter of movement of a sensed object. Nonlimiting examples of scaling parameters include distance, speed, acceleration, etc. Movement of a sensed object may be scaled away from a one-to-one correspondence with movement of a virtual object. For example, movement may be amplified or attenuated relative to actual movement of the sensed object. In one particular example, a user's actual head may rotate 15° (yaw rotation) to the right may be amplified so that a virtual representation of the user's head may rotate 90° (yaw rotation) to the right. As another example, a baseball bat controllable by a user is swung through a full range of motion at 2 feet per second and the speed may be amplified so that a virtual baseball bat is swung at a speed of 10 feet per second.

It will be appreciated that movement of the sensed object may be scaled in virtually any suitable manner. For example, the scaling may be linear or non-linear. Further, movement of the sensed object may be scaled along any of the translational axes and/or the rotational axes in six degrees of freedom. Moreover, scaled movement may be realized by the control commands generated by the engine software that effect control of the rendered scene.

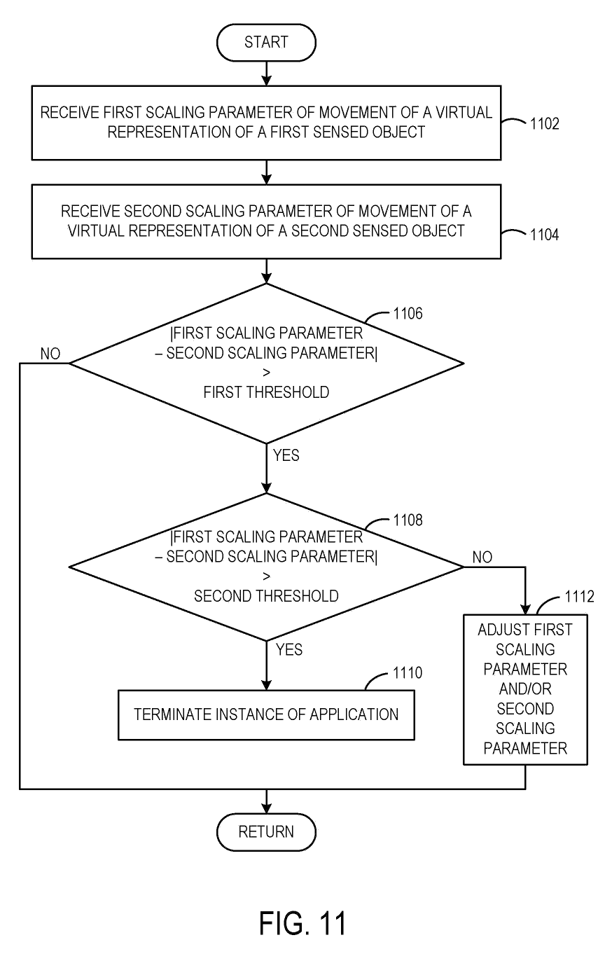

In some embodiments, scaling may be set and/or adjusted based on user input. In some embodiments, scaling may be set and/or adjusted based on a particular software application. In some embodiments, scaling may be set and/or adjusted based a type of sensing apparatus. It will be appreciated that scaling may be set and/or adjusted by other sources. In some embodiments, two or more of the above sources may be used to set and/or adjust scaling. Scaling adjustment arbitration will be discussed in further detail with reference to FIG. 11.

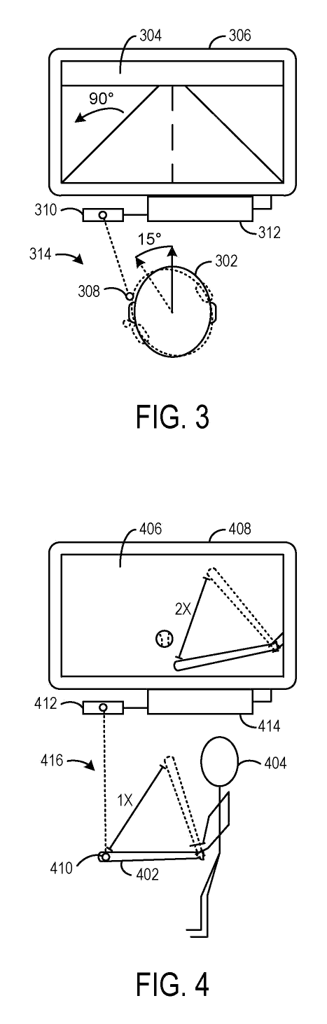

FIG. 3 depicts an example of a user's head 302 being employed as a sensed object to control presentation of a rendered scene 304 on a display 306. In particular, sensed locations 308 fixed relative to user's head 302 may be sensed by sensors 310 and positional data may be sent to computer 312 which may be operatively coupled with display 306 to present rendered scene 304. In this example, translational and/or rotational motion of the user's head may correspond to scaled translational and/or rotational motion of a first person perspective of a virtual environment. In one example, movement of the user's head may be amplified to produce scaled movement of the first person perspective that is greater than the actual movement of the user's head.

For example, at 314 the user's head may be initially positioned facing the display and may rotate 15° to the left along the yaw axis which may generate 90° of rotation to the left along the yaw axis of the first person perspective of the rendered scene. The user's head represented by solid lines may be representative of the initial orientation of the user's head. The user's head represented by dashed lines may be representative of the orientation of the user's head after the yaw rotation.

It will be appreciated that virtually any part of a user's body may be employed as a sensed object to control presentation of a virtual first person perspective of a rendered scene. Further, a user's body part may be employed to control a virtual representation of the user's body part in the rendered scene. In particular, actual movement of the user's body part may correspond to scaled movement of the virtual representation of the user's body part in the rendered scene. Further, it will be appreciated that a plurality of body parts of a user may be employed as sensed objects.

FIG. 4 depicts an example of an external object 402 controllable by a user 404 being employed as a sensed object to control presentation of a rendered scene 406 on a display 408. In particular, sensed locations 410 fixed relative to external object 402 may be sensed by sensors 412 and positional data may be sent to computer 414 which may be operatively coupled with display 408 to present rendered scene 406. In this example, the external object simulates a baseball bat which may be moved in a swinging motion to control movement of a virtual representation of a baseball bat presented from a third person perspective in the rendered scene. In particular, translational and/or rotational motion of the baseball bat may correspond to scaled translational and/or rotational motion of a virtual representation of the baseball bat in the rendered scene of a virtual environment. In one example, the speed of movement of the baseball bat may be amplified to produce scaled movement of the virtual representation of the baseball bat that is performed at a greater speed than the actual movement of the baseball bat.

For example, at 416, initially, the user may be holding the baseball bat away from the display and may perform a full swing motion at a speed of IX that translates and rotates the baseball bat in a direction towards the display which, in turn, may generate a swing motion of the virtual representation of the baseball bat in the rendered scene that is amplified to the speed of 2× or twice the swing speed of the actual baseball bat. It will be appreciated that, in some cases, the rotational and translational motion of the baseball bat may be scaled as well as the speed in which the swing motion is performed. The baseball bat represented by solid lines may be representative of the initial orientation of the baseball bat. The baseball bat represented by dashed lines may be representative of the orientation of the baseball bat after the rotation and translation.

It will be appreciated that virtually any suitable type of external object may be employed as a sensed object to control presentation of a virtual representation of the external object in a rendered scene. In particular, actual movement of the external object may correspond to scaled movement of the virtual representation of the external object in the rendered scene. In some examples, sensed locations may be integrated into the external object. For example, a baseball bat may include sensors that are embedded in a sidewall of the barrel of the baseball bat. In some examples, sensed locations may be affixed to the eternal object. For example, a sensor array may be coupled to a baseball bat. Further, it will be appreciated that a plurality of external objects may be employed as different sensed objects controlling different virtual representations and/or aspects of a rendered scene. Moreover, in some embodiments, one or more body parts of a user and one or more external objects may be employed as different sensed objects to control different aspect of a rendered scene.

As discussed above, a user may interact with one or more other users in a shared virtual environment that may be generated by a software application. In one example, at least one of the users controls an aspect of the virtual environment via control of a sensed object. In particular, the sensed object controls presentation of a virtual representation of the sensed object in the shared virtual environment, such that movement of the sensed object corresponds to scaled movement of the virtual representation of the sensed object in the shared virtual environment. Further, other users interacting with the shared virtual environment perceive the scaled movement of the virtual representation of the sensed object as controlled by the user. For example, a user playing a virtual reality baseball game with other users swings an actual baseball bat at a first speed, and a virtual representation of the virtual baseball bat having scaled speed is presented to other users

Although it may be desirable for an actual object to have one-to-one correspondence with a virtual object (e.g., actual head moves virtual head), it will be appreciated that a movement of an actual object may control presentation of a virtual object that does not correspond one-to-one with the actual object (e.g., actual head moves virtual arm).

Furthermore, in some examples, each of the users interacting with the shared virtual environment may control a different sensed object; and movement of each of the different sensed objects may control presentation of a different virtual representation of that sensed object in the shared virtual environment. Actual movement of each of the sensed objects may be scaled differently (or the same), such that the same actual movement of two different sensed objects may result in different (or the same) scaled movement of the virtual representations of the two different sensed objects in the shared virtual environment. Accordingly, in some cases, a user interacting with the shared virtual environment may perceive virtual representations of sensed objects controlled by other users of the shared virtual environment and the movement of the virtual representations of the sensed objects based on actual movement of the sensed objects may be scaled differently for one or more of the different users.

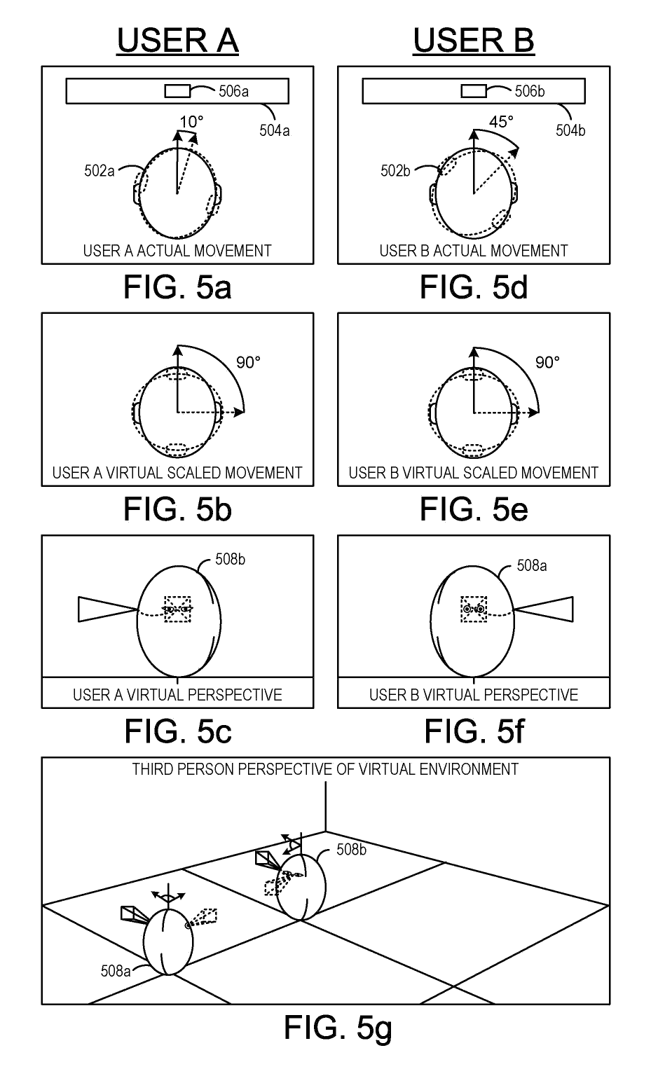

FIGS. 5a-5g depict exemplary aspects of a shared virtual environment in which virtual representations of different sensed objects controlled by different users may interact with each other. In this example, a first sensed object may be the head of a user A and a second sensed object may be the head of a user B. Further, movement of user A's head may correspond to scaled movement of a virtual head of user A and movement of user B's head may correspond to scaled movement of a virtual head of user B in the shared virtual environment. Note that in this example, the movement of user A's head is scaled differently than the movement of user B's head.

FIGS. 5a and 5d depict top views of the actual head 502a of user A and the actual head 502b of user B in relation to a display 504a and 504b, which may display rendered scenes of the shared virtual environment to user A and to user B. As previously discussed, a sensor such as a camera 506a, and 506b may be mounted proximate to the computer display or placed in another location, and is configured to track movement of user A's head and user B's head. FIGS. 5b and 5e depict scaled movement of user A's virtual head and user B's virtual head generated based on the actual movement of user A's head and user B's head. FIG. 5c depicts a first person perspective rendered scene of the shared virtual environment including the virtual representation of user B's head as seen from the perspective of the virtual head of user A that is perceivable by user A. FIG. 5f depicts a first person perspective rendered scene of the shared virtual environment including the virtual representation of user A's head as seen from the perspective of the virtual head of user B that is perceivable by user B. The rendered scenes may be displayed to the users via computer displays 504a and 504b. FIG. 5g shows a third person perspective of the shared virtual environment where the virtual heads of user A and user B are interacting with each other.

In the present discussion, the depictions of FIGS. 5b and 5d serve primarily to illustrate the first-person orientation within the virtual reality environment, to demonstrate the correspondence between positions of the user's heads (shown in FIGS. 5a and 5d) and the first person perspective rendered scenes of the shared virtual environment (shown in FIGS. 5c and 5f) that are displayed to the users.

In FIGS. 5c, 5f, and 5g, a virtual perspective of the shared environment presented from the perspective of a virtual head of a user may be depicted as a pyramidal shape representative of a line of sight extending from a position of virtual eyes of the virtual head. The initial position of the virtual perspective of each of the virtual heads may be represented by solid lines and the position of the virtual perspective of each of the virtual heads after a scaled rotation is performed by the virtual heads may be represented by dashed lines.

It will be appreciated that in FIGS. 5a-5h, the initial position/direction of the perspective of user A and the initial position/direction of the perspective of user B are represented by solid lines and the rotated position/direction of the perspective of user A and the rotated position/direction of the perspective of user B are represented by dashed lines.

Continuing with the discussion of user A, in FIG. 5a, the initial position of user A's head 502a is depicted in a neutral, centered position relative to sensor 506a and display 504a. The head is thus indicated as being in a 0° position (yaw rotation). As shown in FIG. 5b, the corresponding initial virtual position is also 0° of yaw rotation, such that the virtual head of user A is orientated facing away from the virtual head of user B and user A is presented with a view of a wall in the virtual shared environment (as seen in FIG. 5g) via display 504a.

Continuing with FIG. 5a, user A may perform a yaw rotation of user A's head to the right to a 10° position (yaw rotation). As shown in FIG. 5b, the corresponding virtual position is 90° of yaw rotation, such that the virtual head 508a of user A is oriented facing the virtual head 508b of user B and user A is presented with a view of a user B in the virtual shared environment (as seen in FIGS. 5c and 5h).

Turning to discussion of user B, in FIG. 5d, the initial position of user B's head 502b is depicted in a neutral, centered position relative to sensor 506b and display 504b. The head is thus indicated as being in a 0° position (yaw rotation). As shown FIG. 5e, the corresponding initial virtual position is also 0° of yaw rotation, such that the virtual head of user B is orientated facing away from the virtual head of user A and user B is presented with a view of a wall in the virtual shared environment (as seen in FIG. 5g) via display 504b.

Continuing with FIG. 5d, user B may perform a yaw rotation of user B's head to the right to a 45° position (yaw rotation). As shown in FIG. 5e, the corresponding virtual position is 90° of yaw rotation, such that the virtual head 508b of user B is oriented facing the virtual head of user A and user B is presented with a view of user A in the virtual shared environment (as seen in FIGS. 5c and 5h). The yaw rotation of the head of user A is upward scaled or amplified to a greater degree than the yaw rotation of the head of user B, so in this example, a yaw rotation of user A's actual head that is smaller than a yaw rotation of user B's actual head may result in the same amount of yaw rotation of user A's virtual head and user B's virtual head Furthermore, user A's yaw rotation results in the virtual first person perspective of user A being positioned to view user B's virtual head in the shared virtual environment. Thus, user A may perceive scaled movement of the virtual representation of user B's head in the shared virtual environment that corresponds to movement of user B's actual head via a rendered scene presented on the display viewable by user A. Likewise, user B may perceive scaled movement of the virtual representation of user A's head in the shared virtual environment that corresponds to movement of user A's actual head via a rendered scene presented on the display viewable by user B.

By controlling presentation of a virtual reality game such that actual movement of an object corresponds to scaled movement of a virtual representation of that object, a user may perceive the virtual reality game to be more immersive. In other words, by permitting a user to move their head to control presentation of a rendered scene of the virtual reality video game, the user may feel that game play is enhanced relative to controlling presentation of a rendered scene using an input device in which actual movement does not correspond to virtual movement. Moreover, in a multi-player virtual reality video game, by permitting players to move different sensed objects to control, through scaled movement, different virtual representations of the sensed objects in a shared virtual environment, where movement of the different virtual objects is scaled differently, game play may be further enhanced since for each user scaled movement of an object may be adjusted to a desired scaling, yet all of the users may perceive scaled movement of virtual objects in the virtual environment.

It will be appreciated that a wide variety of scaling correlations may be employed between the actual movement and the control that is effected over the computer. In virtual movement settings, correlations may be scaled, linearly or non-linearly amplified, position-dependent, velocity-dependent, acceleration-dependent, etc. Furthermore, in a system with multiple degrees of freedom or types of movement, the scaling correlations may be configured differently for each type of movement. For example, in the six-degrees-of-freedom system discussed above, the translational movements could be configured with deadspots, and the rotational movements could be configured to have no deadspots. Furthermore, the scaling or amplification could be different for each of the degrees of freedom.

FIGS. 6-10 depict different examples of system configurations in which multiple users may control different sensed objects and movement of the different sensed objects may correspond to scaled movement of virtual representations of the different sensed object perceivable by the multiple users in a shared virtual environment.

FIG. 6 depicts an example system configuration where a first user interacts with the shared virtual environment via a first motion control system that presents a first person perspective rendered scene to the first user, and a second user interacts with the shared virtual environment via a second motion control system that presents a first person perspective rendered scene to the second user, and the first motion control system is in operative communication with the second motion control system. In particular, sensed locations 602 positioned fixed relative to a first user's head 604 may be sensed by sensor 606 in operative communication with a first computer 608 and motion of first user's head 604 may control presentation of a first rendered scene 610 of the shared virtual environment presented on a first display 612. The motion of first user's head 604 may correspond to scaled motion of a virtual representation 614 of the first user's head in the shared virtual environment perceivable by the second user on a second display 616. Likewise, sensed locations 618 positioned fixed relative to a second user's head 620 may be sensed by sensor 622 in operative communication with a second computer 624 and motion of second user's head 620 may control presentation of a second rendered scene 626 of the shared virtual environment presented on second display 616. The motion of second user's head 620 may correspond to scaled motion of a virtual representation 628 of the second user's head in the shared virtual environment perceivable by the first user on first display 612. The rendered scenes presented to the first and second users may be first person perspectives in which the virtual representations of the first and second user's heads are perceivable by the other user (i.e. the first user may perceive the virtual representation of the second user's head and the second user may perceive the virtual representation of the first user's head). It will be appreciated that the first computer and the second computer may be located proximately or remotely and may communicate via a wired or wireless connection.

FIG. 7 depicts an example system configuration where a first user interacts with the shared virtual environment via a first motion control system that presents a third person perspective rendered scene to the first user, and a second user interacts with the shared virtual environment via a second motion control system that presents a third person perspective rendered scene to the second user, and the first motion control system is in operative communication with the second motion control system. In particular, sensed locations 702 positioned fixed relative to a first user's head 704 may be sensed by sensor 706 in operative communication with a first computer 708 and motion of first user's head 704 may control presentation of a rendered scene 710 of the shared virtual environment presented on a first display 712. The motion of first user's head 704 may correspond to scaled motion of a virtual representation 714 of the first user's head in the shared virtual environment perceivable by the second user on a second display 716. Likewise, sensed locations 718 positioned fixed relative to a second user's head 720 may be sensed by sensor 722 in operative communication with a second computer 724 and motion of second user's head 720 may control presentation of rendered scene 710 of the shared virtual environment presented on second display 716. The motion of second user's head 720 may correspond to scaled motion of a virtual representation 726 of the second user's head in the shared virtual environment perceivable by the first user on first display 712. The rendered scene presented to the first and second users may be a third person perspective in which the virtual representations of the first and second user's heads are perceivable by the other user (i.e. the first user may perceive the virtual representation of the second user's head and the second user may perceive the virtual representation of the first user's head). It will be appreciated that the first computer and the second computer may be located proximately or remotely and may communicate via a wired or wireless connection.

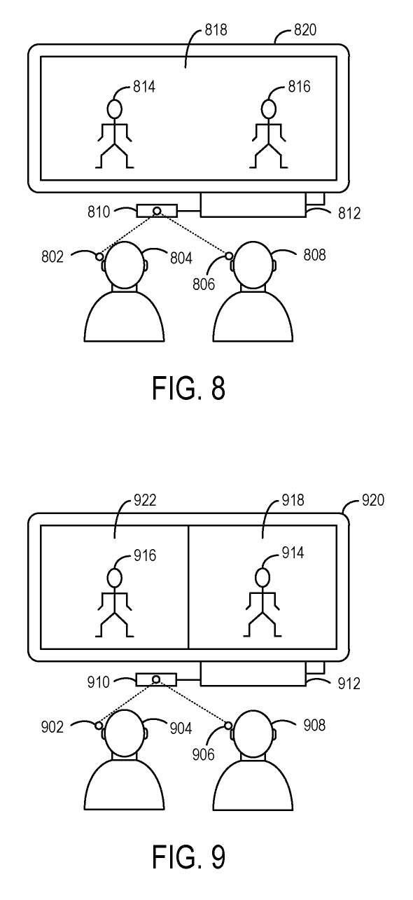

FIG. 8 depicts an example system configuration where a first user and a second user interact with a shared virtual environment via a motion control system that presents a third person perspective rendered scene to the first user and the second user on a single display. In particular, sensed locations 802 positioned fixed relative to a first user's head 804 and sensed locations 806 positioned fixed relative to a second user's head 808 may be sensed by a sensor 810 in operative communication with a computer 812. Motion of first user's head 804 may control presentation a virtual representation 814 of the first user's head and motion of second user's head 808 may control presentation of a virtual representation 816 of the second user's head in a third person perspective rendered scene 818 of the shared virtual environment presented on a display 820. More particularly, the motion of first user's head 804 may correspond to scaled motion of virtual representation 814 of the first user's head in the shared virtual environment perceivable by the second user on display 820 and the motion of second user's head 808 may correspond to scaled motion of virtual representation 816 of the second user's head in the shared virtual environment perceivable by the first user on display 820. It will be appreciated that a single sensor may sense the sensed locations of both the first and second user and the third person perspective rendered scene may be presented on a single display perceivable by the first and second user. In this example configuration, the first and second users may share a single motion control system, thus facilitating a reduction in system hardware components relative to the configurations depicted in FIGS. 6 and 7.

FIG. 9 depicts an example system configuration where a first user and a second user interact with a shared virtual environment via a motion control system that presents a different first person perspective rendered scene to each of the first user and the second user on a single display concurrently. In particular, sensed locations 902 positioned fixed relative to a first user's head 904 and sensed locations 906 positioned fixed relative to a second user's head 908 may be sensed by a sensor 910 in operative communication with a computer 912. Motion of first user's head 904 may control presentation of a first person perspective rendered scene 922 and motion of second user's head 908 may control presentation of a second first person perspective rendered scene 918. The motion of first user's head 904 may correspond to scaled motion of virtual representation 914 of the first user's head in the shared virtual environment in second rendered scene 918 perceivable by the second user on display 920 and the motion of second user's head 908 may correspond to scaled motion of virtual representation 916 of the second user's head in the shared virtual environment in first rendered scene 922 perceivable by the first user on display 920. Presentation of first rendered scene 922 and second rendered scene 918 concurrently on display 920 may be referred to as a split screen presentation. It will be appreciated that a single sensor may sense the sensed locations of both the first and second user and the first and second first person perspective rendered scenes may be presented on a single display perceivable by the first and second user. In this example configuration, the first and second users may share a single motion control system, thus facilitating a reduction in system hardware components relative to the configurations depicted in FIGS. 6 and 7.

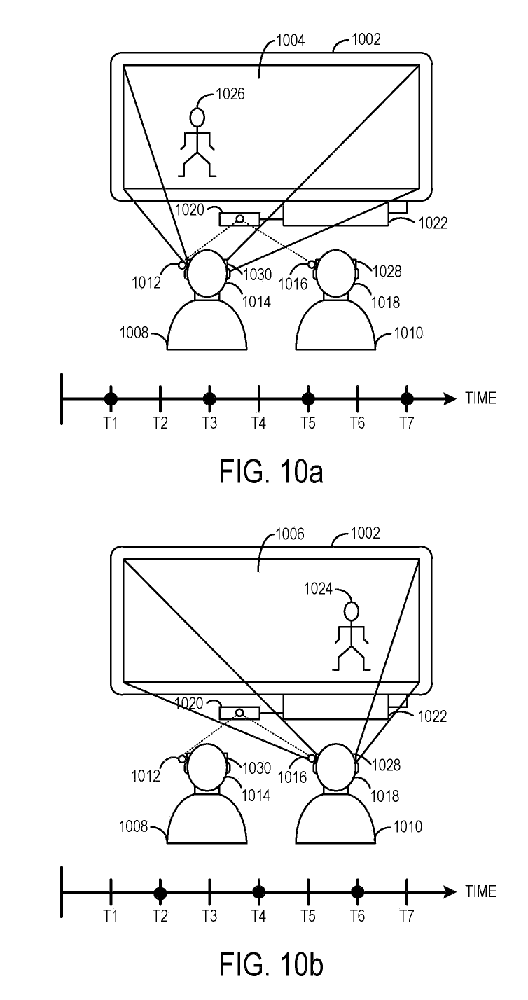

FIGS. 10a-10b depict an example system configuration where a first user and a second user interact with a shared virtual environment via a motion control system that presents a different rendered scene to each of the first user and the second user on a single display such that the different rendered scenes are presented in an alternating fashion on the display in what may be referred to as interleaved presentation. In particular, display 1002 may be configured to alternate presentation of a first rendered scene 1004 directed at a first user 1008 and a second rendered scene 1006 directed at a second user 1010. The display may refresh presentation of the rendered scenes at a suitably high refresh rate (e.g. 120+ Hz) in order to reduce or minimize a flicker effect that may be perceivable by the users due to the interleaved presentation of the rendered scenes.

To enhance the interleaved presentation of the rendered scenes, each user may be outfitted with an optic accessory capable of selectively blocking view through the optic accessory in cooperation with the refresh rate of the display. In one example, the optic accessory may include a pair of shutter glasses which employ LC (liquid crystal) technology and a polarizing filter in which an electric voltage may be applied to make the glasses dark to block the view of the user. The shutter glasses may be in operative communication with the computer and may receive signals from the computer that temporally correspond with presentation of a rendered scene and the signals may cause the shutter glasses to block the user from perceiving the rendered scene. It will be appreciated that virtually any suitable light manipulation technology may be employed in the shutter glasses to selectively block the view of the user wearing the shutter glasses.

Continuing with FIGS. 10a-10b, sensed locations 1012 positioned fixed relative to a first user's head 1014 and sensed locations 1016 positioned fixed relative to a second user's head 1018 may be sensed by a sensor 1020 in operative communication with a computer 1022. Motion of first user's head 1014 may control presentation of first rendered scene 1004 which may be a first person perspective of the virtual shared environment as viewed from the virtual head of the first user and motion of second user's head 1018 may control presentation of second rendered scene 1006 which may be a first person perspective of the virtual shared environment as viewed from the virtual head of the second user. The motion of first user's head 1014 may correspond to scaled motion of virtual representation 1024 of the first user's head in the shared virtual environment in second rendered scene 1006 perceivable by the second user on display 1002 and the motion of second user's head 1018 may correspond to scaled motion of virtual representation 1026 of the second user's head in the shared virtual environment in first rendered scene 1004 perceivable by the first user on display 1002.

During time intervals T1, T3, T5, and T7, first rendered scene 1004 may be presented on display 1002. During these time intervals, optical accessory 1028 worn by the second user may receive signals from computer 1022 that block the view of the second user through the shutter glasses preventing the second user from perceiving first rendered scene 1004. Concurrently, the first user may perceive the scaled motion of virtual representation 1026 of the second user's head in the shared environment in first rendered scene 1004 since optical accessory 1030 worn by the first user does not receive signals from computer 1022 during these time intervals and therefore are transparent.

During time intervals T2, T4, and T6, second rendered scene 1006 may be presented on display 1002. During these time intervals, optic accessory 1030 worn by the first user may receive signals from computer 1022 that block the view of the first user through the optic accessory preventing the first user from perceiving second rendered scene 1006. Concurrently, the second user may perceive the scaled motion of virtual representation 1024 of the first user's head in the shared environment in second rendered scene 1006 since optic accessory 1028 worn by the second user does not receive signals from computer 1022 during these time intervals and therefore are transparent.

It will be appreciated that control of presentation of rendered scenes on a display configured to present rendered scenes having virtual representations with scaled movement via interleaved presentation may be realized by motion control technology in which motion of a sensed object controls a virtual representation that does not correspond to the sensed object. For example, a mouse or other input device may be used to control scaled movement of a virtual representation in a shared environment in a rendered scene.

It will be appreciated that the example configurations discussed above with reference to FIGS. 6-10 may be expanded to include more than two users. For example, in an interleaved display configuration, three different rendered scenes may be repeatedly displayed in succession and three different users may each view one of the three rendered scenes.

In some embodiments, variations in the magnitude of one or more scaling parameters of different users may affect the execution of a multi-user software application, and more particularly, a multi-player virtual reality game. For example, differences in scaling of two different users may be so great that the scaled movement of virtual representations in a shared environment controlled by the users may degrade presentation of the shared virtual environment in rendered scenes to the point that realistic or desired presentation may not be feasible. As another example, differences in scaling of two different users may be so great that the scaled movement of virtual representations in a shared environment controlled by the users may create an unfair advantage for one of the users. Thus, in some cases, scaling arbitration may be employed in order to suitably execute a multi-user software application that involves scaled movement of virtual representations controlled by sensed objects.

FIG. 11 depicts a flow diagram representative of an example method of arbitrating scaling of movement of different virtual representations of different sensed objects in a shared virtual environment.

The flow diagram begins at 1102, where the method may include receiving a first scaling parameter of movement of a virtual representation of a first sensed object.

Next at 1104, the method may include receiving a second scaling parameter of movement of a virtual representation of a second sensed object. It will be appreciated that a scaling parameter may characterize virtually any suitable aspect of scaled movement. Nonlimiting examples of scaling parameters may include translational and/or rotational distance, speed, acceleration, etc.

Next at 1106, the method may include determining if a differential of the first scaling parameter and the second scaling parameter exceeds a first threshold. In one example, the differential may include the absolute value of the first scaling parameter subtracted from the second scaling parameter. In some embodiments, the first threshold may be user defined. In some embodiments, the first threshold may be software application defined. If it is determined that the differential of the first and second scaling parameter exceeds the first threshold the flow diagram moves to 1108. Otherwise, the flow diagram ends.

At 1108, the method may include determining if the differential of the first scaling parameter and the second scaling parameter exceeds a second threshold. In some embodiments, the second threshold may be user defined. In some embodiments, the second threshold may be software application defined. If it is determined that the differential of the first and second scaling parameters exceeds the second threshold the flow diagram moves to 1110. Otherwise, the differential of the first and second scaling parameters does not exceed the second threshold and the flow diagram moves to 1112.

At 1110, the method may include terminating the instance of the software application due to the fact that the first and second scaling parameters are too varied based on the second threshold. In one example, the instance of the software application may be terminated because suitable execution of the software application or rendering of images may not be feasible. In another example, the instance of the software application may be terminated because the advantage created by the difference in scaling parameter may not be desirable for one or more users or groups of users. It will be appreciated that the instance of the software application may be terminated based on other suitable reasons without departing from the scope of the present disclosure.

At 1112, the method may include adjusting at least one of the first scaling parameter and the second scaling parameter. Adjusting a scaling parameter may include amplifying the scaling parameter or attenuating the scaling parameter. In some cases, the scaling parameters may be adjusted to have the same value. In some cases, one scaling parameter may be amplified and the other scaling parameter may be attenuated. In some cases, a scaling parameter may be adjusted based on a user's ability which may be determined by the software application. By adjusting scaling of different users, a game play advantage may be negated or optimized and/or execution of a software application may be improved. In this way, the game play experience of users interacting in a multi-user software application may be enhanced.

It will be appreciated that the method may be repeated for a plurality of scaling parameters. Further, the method may be performed at the initiate of a software application and/or may be performed repeatedly throughout execution of a software application. In some embodiments, the method may be expanded upon to negotiate scaling between more than two different sensed objects. In some embodiments, the method may include detecting if different users have a particular scaling parameter enabled and adjusting that particular scaling parameter of other users based on a user not having the scaling parameter enabled. Further, in some embodiments, the method may include selectively adjusting scaling parameters of one or more users based on user defined and/or software application define parameter, environments, etc. In some embodiments, the method may include selectively adjusting/disabling scaling parameters of one or more users based on a type of input peripheral used by one or more of the users. For example, scaling may be adjusted/disabled for a user controlling presentation via a sensed object based on another user controlling presentation via a mouse input device.

It will be appreciated that principles discussed in the present disclosure may be applicable to a forced perspective environment. In particular, multiple users may control different sensed objects to control presentation of virtual objects in rendered scene(s) having a forced perspective of a virtual shared environment. Motion of the sensed object may correspond to scaled motion of the virtual objects in the forced perspective rendered scene(s).

It will be appreciated that the embodiments and method implementations disclosed herein are exemplary in nature, and that these specific examples are not to be considered in a limiting sense, because numerous variations are possible. The subject matter of the present disclosure includes all novel and nonobvious combinations and subcombinations of the various intake configurations and method implementations, and other features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. A system for controlling operation of a computer, comprising:
a sensing apparatus configured to obtain positional data of a sensed object controllable by a first user, such positional data varying in response to movement of the sensed object; and
engine software operatively coupled with the sensing apparatus and configured to produce control commands based on the positional data, the control commands being operable to control, in a multi-user software application executable on the computer, presentation of a virtual representation of the sensed object in a virtual environment shared by the first user and a second user, the virtual representation of the sensed object being perceivable by the second user in a rendered scene of the virtual environment,
where the engine software is configured so that the movement of the sensed object produces control commands which cause corresponding scaled movement of the virtual representation of the sensed object in the rendered scene that is perceivable by the second user.

2. The system of claim 1, wherein the rendered scene is perceivable by the first user and the second user via a single display device.

3. The system of claim 2, wherein the engine software and the multi-user software application are executable on the computer and the computer is in operative communication with the single display device, such that the rendered scene is displayed on the single display device.

4. The system of claim 1, wherein the rendered scene is perceivable by the first user via a first display device and perceivable by the second user via a second display device.

5. The system of claim 1, wherein the multi-user software application is configured to present a rendered scene of the virtual environment that is perceivable by the first user that differs from the rendered scene that is perceivable by the second user.

6. The system of claim 5, wherein the rendered scene of the virtual environment that is perceivable by the first user is displayed on a first display device and the rendered scene that is perceivable by the second user is displayed on a second display device.

7. The system of claim 5, wherein the rendered scene of the virtual environment that is perceivable by the first user and the rendered scene that is perceivable by the second user are displayed on a single display device.

8. The system of claim 7, wherein the single display device is configured to display different interleaved rendered scenes and the rendered scene of the virtual environment that is perceivable by the first user and the rendered scene that is perceivable by the second user are displayed alternately on the single display device.

9. The system of claim 1, wherein the sensed object is a body part of the first user.

10. The system of claim 2, wherein the sensed object is a head of the first user.

11. The system of claim 1, wherein the sensed object is configured to be held by the first user.

12. The system of claim 1, wherein the sensing apparatus and engine software are configured to resolve translational motion of the sensed object along an x-axis, y-axis and z-axis, each axis being perpendicular to the other two axes, and to resolve rotational motion of the sensed object about each of the x-axis, y-axis and z-axis.

13. Computer-readable media including instructions that, when executed by a processor of a computer:
produce control commands in response to receiving positional data of a first sensed object controllable by a first user, such positional data varying in response to movement of the first sensed object; and
control display of a rendered scene of a virtual environment shared by the first user and a second user, the rendered scene including a virtual representation of the first sensed object moveable in the virtual environment based on the control commands, wherein the control commands are configured so that movement of the first sensed object causes corresponding scaled movement of the virtual representation of the first sensed object in the rendered scene that is perceivable by the second user.

14. The computer-readable media of claim 13, further including instructions, that when executed by a processor of a computer:
produce a second set of control commands in response to receiving positional data of a second sensed object controllable by the second user, such positional data varying in response to movement of the second sensed object; and
control display of a second rendered scene of the virtual environment shared by the first user and the second user, the rendered scene including a virtual representation of the second sensed object moveable in the virtual environment based on the second set of control commands, wherein the second set of control commands are configured so that movement of the second sensed object causes corresponding scaled movement of the virtual representation of the sensed object in the second rendered scene that is perceivable by the first user.

15. The computer-readable media of claim 14, wherein the movement of the first sensed object and the movement of the second sensed object are scaled differently to produce movement of the corresponding virtual representations of the sensed objects.

16. The computer-readable media of claim 14, wherein the movement of the first sensed object and the movement of the second sensed object are scaled the same to produce movement of the corresponding virtual representations of the sensed objects.

17. The computer-readable media of claim 14, wherein the position data of the first sensed object and the position data of the second sensed object are generated from a single sensing apparatus.

18. A method of controlling presentation of a virtual representation of a first sensed object controllable by a first user and a virtual representation of a second sensed object controllable by a second user in a shared virtual computing environment, the method comprising:
receiving a first scaling parameter used to resolve movement of the virtual representation of the first sensed object, such that actual movement of the first sensed object corresponds to scaled movement of the virtual representation of the first sensed object based on the first scaling parameter;
receiving a second scaling parameter used to resolve movement of the virtual representation of the second sensed object, such that actual movement of the second sensed object corresponds to scaled movement of the virtual representation of the second sensed object based on the second scaling parameter;
adjusting at least one of the first scaling parameter and the second scaling parameter in response to a differential of the first scaling parameter and the second scaling parameter exceeding a predetermined threshold;
controlling display of a first rendered scene perceivable by the second user in response to adjustment of the first scaling parameter, the first rendered scene presenting the virtual representation of the first sensed object, such that movement of the virtual representation of the first sensed object is based on an adjusted first scaled parameter; and
controlling display of a second rendered scene perceivable by the first user in response to adjustment of the second scaling parameter, the second rendered scene presenting the virtual representation of the second sensed object, such that movement of the virtual representation of the second sensed object is based on an adjusted second scaled parameter.

19. The method of claim 18, wherein at least one of the first scaling parameter and the second scaling parameter is defined by a user.

20. The method of claim 18, wherein at least one of the first scaling parameter and the second scaling parameter is defined by a software application.

21. A system for controlling operation of a computer, comprising:
at least one input device configured to obtain positional data from input of a first user and positional data from input of a second user;
engine software operatively coupled with the at least one input device and configured to produce control commands based on the positional data of the input of the first user and the input of the second user, the control commands being operable to control, in a multi-user software application executable on the computer, presentation of a first virtual object in a shared virtual environment in a first rendered scene and presentation of a second virtual object in the shared virtual environment in a second rendered scene, where the engine software is configured so that input of the first user produces control commands which cause scaled movement of the first virtual object in the first rendered scene and input of the second user produces control commands which cause scaled movement of the second virtual object in the second rendered scene; and
a display subsystem in operative communication with at least one of the multi-user software application and the engine software, the display subsystem being configured to alternately present the first rendered scene and the second rendered scene, such that the scaled movement of the first virtual object in the first rendered scene is perceivable by the second user and the scaled movement of the second virtual object in the second rendered scene is perceivable by the first user.

22. The system of claim 21, wherein the display subsystem further comprises:
a first optical accessory wearable by the first user, the first optical accessory configured to block a view through the first optical accessory in response to receiving a signal from the computer corresponding to presentation of the second rendered scene by the display subsystem, such that the first user may not perceive presentation of the second rendered scene; and
a second optical accessory wearable by the second user, the second optical accessory configured to block a view through the second optical accessory in response to receiving a signal from the computer corresponding to presentation of the first rendered scene by the display subsystem, such that the second user may not perceive presentation of the first rendered scene.

23. The system of claim 22, wherein the first optical accessory and the second optical accessory are liquid crystal shutter glasses.

24. The system of claim 21, wherein the at least one input device includes a sensing apparatus and the input of the first user is generated based on movement of a first sensed object controllable by the first user and the input of the second user is generated based on movement of a second sensed object controllable by the second user.

25. The system of claim 21, wherein the movement of the first virtual object is scaled differently than the movement of the second virtual object.

26. The system of claim 25, wherein at least one of the engine software and the multi-user software application is configured to adjust at least one of a first scaling parameter of the first virtual object and a second scaling parameter of the second scaling object in response to the differential between the first scaling parameter and the second scaling parameter exceeding a predetermined threshold.

27. The system of claim 21, wherein at least one of the first virtual object corresponds to a first object controllable by the first user to generate the input of the first user, such that movement of the first object corresponds to scaled movement of the first virtual object, and the second virtual object corresponds to a second object controllable by the second user to generate the input of the second user, such that movement of the second object corresponds to scaled movement of the second virtual object.
